(19) United States
(12) Patent Application Publication
(10) Pub. No.: US 2011/0190038 A1
(43) Pub. Date: Aug. 4, 2011

(54) COMMUNICATION DEVICE AND COMMUNICATION CONTROL METHOD

(75) Inventor: Masanori NAKANO, Tokyo (JP)

(73) Assignee: KABUSHIKI KAISHA TOSHIBA, Tokyo (JP)

(21) Appl. No.: 13/018,214

(22) Filed: Jan. 31, 2011

(30) Foreign Application Priority Data
Jan. 29, 2010 (JP) 2010-019689

(51) Int. Cl. H04W 52/02

(52) U.S. Cl. 455/574; 455/550.1

(57) ABSTRACT

According to one embodiment, a communication device for executing data communication by wireless communication is provided. The communication device includes: a wireless communication module configured to execute the wireless communication with a counterpart communication device; an acceleration detector configured to detect an acceleration of the communication device; and a communication controller configured to determine whether the acceleration exceeds a threshold value, and to disconnect the wireless communication when the communication controller determines that the acceleration exceeds the threshold value.

### CROSS REFERENCE TO RELATED APPLICATION(S)

The present disclosure relates to the subject matter contained in Japanese Patent Application No. 2010-019689 filed on Jan. 29, 2010, which is incorporated herein by reference in its entirety.

### FIELD

Embodiments described herein relate generally to a communication device and a communication control method.

### BACKGROUND

Movement of a communication device is detected by an acceleration sensor or the like provided in the communication device so that functions of the communication device can be controlled based on a result of the detection. For example, assume that a cellular phone is located out of a service range where radio waves can reach, and an acceleration sensor provided in the cellular phone detects zero. In this case, the cellular phone staying still out of the service range is disabled from making a call. Thus, power supply to a wireless portion is suspended. On the other hand, when movement of the cellular phone is detected by the acceleration sensor, the power supply to the wireless portion is resumed. In this manner, power saving can be carried out by controlling the power supply to the wireless portion in accordance with movement of the cellular phone (for example, see JP-A-2007-193546).

In the aforementioned technique, since long range wireless communication is assumed for making a call, wireless communication is disconnected when it is detected that a user carrying the cellular phone is not moving.

For short range wireless communication aimed at performing communication between devices close to each other, it is necessary to keep the positional relationship of the devices close to each other. It is therefore preferable that wireless communication is disconnected during movement of a device. In addition, when wireless communication between devices can be started without authentication operation between the devices as long as the devices are brought close to each other, there is a possibility that unintended wireless communication may be established. In this manner, in short range wireless communication, it is not preferable that communication can be made when a device is moving. It is therefore required to control wireless communication in concert with movement of a device.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is an external view showing a front side of a communication device according to an embodiment.

FIG. 2 is an external view showing a back side of the communication device.

FIG. 3 is a view showing a communication state of the communication device.

FIG. 4 is a flow chart showing a communication control procedure of the communication device.

FIG. 5 is a flow chart showing a communication control procedure of a communication device according to a modification of the embodiment.

### DETAILED DESCRIPTION

In general, according to one embodiment, a communication device for executing data communication by wireless communication is provided. The communication device includes: a wireless communication module configured to execute the wireless communication with a counterpart communication device; an acceleration detector configured to detect an acceleration of the communication device; and a communication controller configured to determine whether the acceleration exceeds a threshold value, and to disconnect the wireless communication when the communication controller determines that the acceleration exceeds the threshold value.

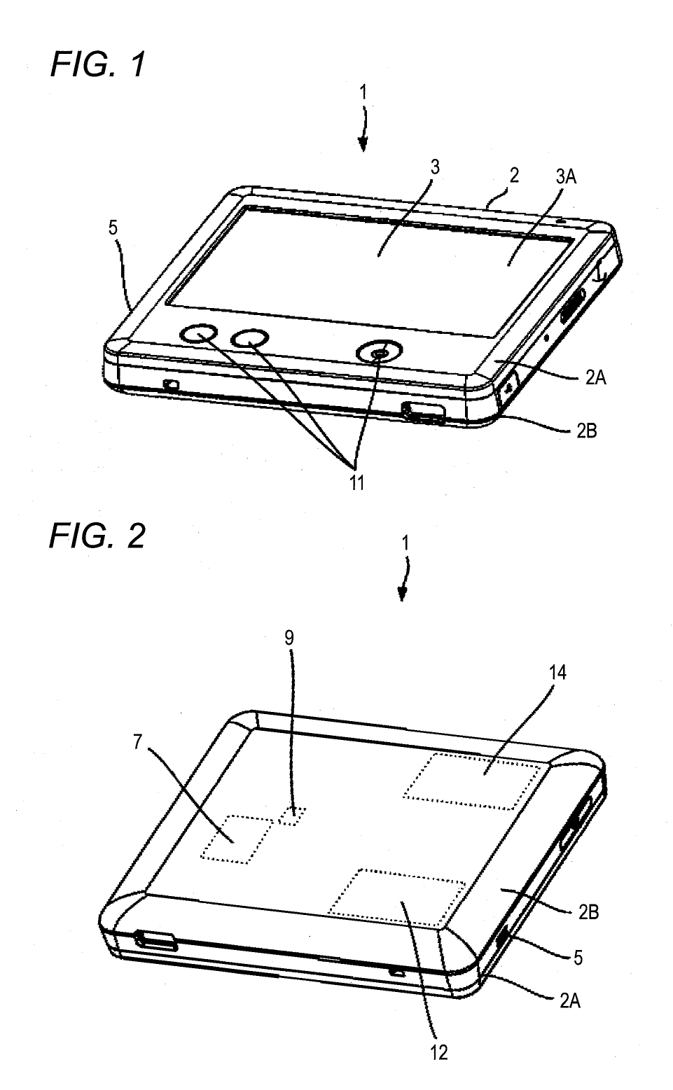

An embodiment of the invention will be described below with reference to FIGS. 1 to 4.

A communication device 1 will be described as an example of a communication device according to the embodiment. The communication device 1 is, for example, a mobile PC, an Ultra Mobile PC (UMPC), a Personal Digital Assistant (PDA), a cellular phone, or the like. In the following description of the embodiment, the communication device 1 will be explained as a device having a box-like housing. However, the communication device 1 is not limited thereto. That is, the communication device 1 may be a device including a display unit and a body unit as separate housings, as represented by a notebook type computer.

Transfer Jet (registered trademark) will be described as wireless communication in the embodiment by way of example. Transfer Jet (registered trademark) does not require user's authentication etc. because wireless communication is established as long as communication devices 1 are brought close to each other.

With reference to FIGS. 1 and 2, the configuration of the communication device 1 will be described. FIG. 1 is an external view showing a front side of the communication device 1. The communication device 1 has a housing 2, a display 3, a speaker 5, a communication antenna 7, an acceleration sensor 9, an input module 11, a battery 12, and a memory 14.

FIG. 2 is an external view showing a back side of the communication device 1. The communication antenna 7, the acceleration sensor 9, the battery 12 and the memory 14 are provided in the housing 2.

A housing cover 2A and a housing base 2B are fitted to each other and assembled into the housing 2. As described above, various electronic components are provided in the housing 2. The housing cover 2A side is defined as a front side of the housing 2, and the housing base 2B side is defined as a back side of the housing 2. A communication direction of the communication antenna 7, that is, a traveling direction of radio waves is a direction from the front side of the housing 2 to the back side of the same.

The display 3 is provided in a center portion where a central portion of the housing cover 2A is cut away. The display 3 displays data or the like transmitted/received by the communication device 1. A touchscreen 3A is laminated on the display 3. The touchscreen 3A is an input device which can input an operating signal if information displayed on the display 3 is touched through the touchscreen 3A. The touchscreen 3A may be replaced, for example, by a tablet (digitizer) in which a position can be indicated by a pen.

The speaker 5 is provided to be exposed in a side surface of the housing 2. The speaker 5 outputs voice, operation sound, etc.

The communication antenna 7 is an antenna designed to be able to perform wireless communication with another communication device 1 so as to transmit/receive data thereto/therefrom.

The acceleration sensor 9 is a sensor for detecting an acceleration of the communication device 1. For example, as the acceleration sensor 9, there is an acceleration sensor which detects a positional change (as a change in electrostatic capacitance) of a movable portion moving by the acceleration and measures the positional change of the moving portion by means of an electric circuit. The acceleration sensor 9 sends out the measured data to an acceleration detector 10.

The input module 11 has buttons for accepting various operations from a user. These buttons are provided in notched portions of the housing cover 2A.

The battery 12 is a power supply for supplying driving power to the communication device 1. The battery 12 is provided in the housing 2.

The memory 14 is a storage medium provided in the communication device 1. The memory 14 is provided in the housing 2. Data transmitted/received through the communication antenna 7 or various kinds of setting information of the communication device 1 are stored in the memory 14.

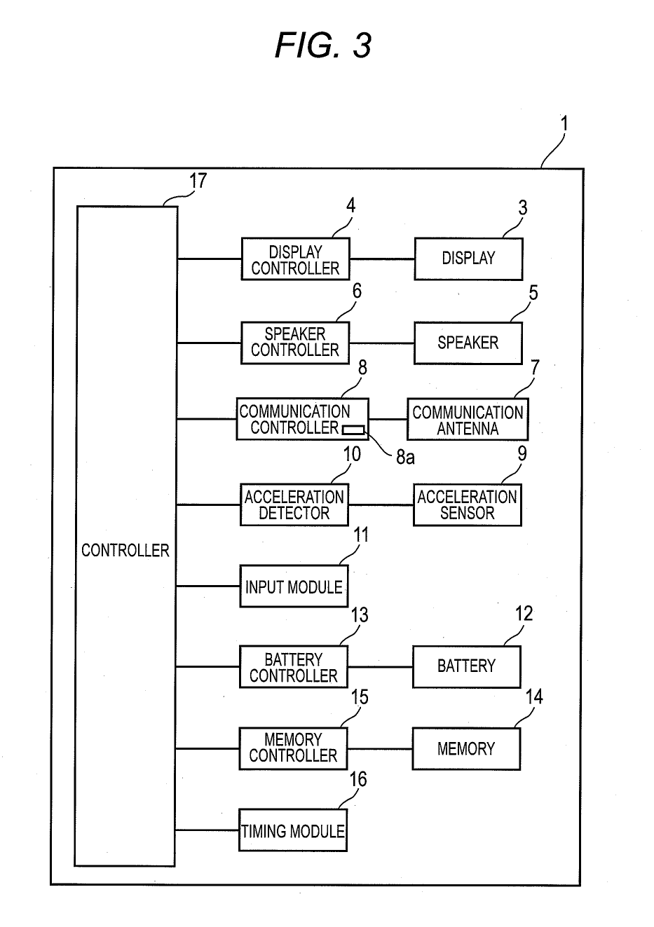

FIG. 3 is a functional block diagram showing the communication device 1. The communication device 1 has the display 3, a display controller 4, the speaker 5, a speaker controller 6, the communication antenna 7, a communication controller 8, the acceleration sensor 9, the acceleration detector 10, the input module 11, the battery 12, a battery controller 13, the memory 14, a memory controller 15, a timing module 16, and a controller 17.

The display controller 4 generates a video signal based on a control signal inputted from the controller 17, and outputs the video signal to the display 3. The display 3 displays video images based on the video signal received from the display controller 4.

The speaker controller 6 generates an audio signal based on a control signal inputted from the controller 17, and outputs the audio signal to the speaker 5. The speaker 5 outputs sound based on the audio signal received from the speaker controller 6.

The communication controller 8 controls a wireless communication function to be performed by the communication antenna 7, in accordance with a detection result from the acceleration detector 10, which result is received from the controller 17. A threshold value for the acceleration detected by the acceleration detector 10 is stored in a register 8a provided in the communication controller 8, and the wireless communication function is controlled using the threshold value. The state where the wireless communication function is ON means a state where electric power is supplied to the communication antenna 7 so that wireless communication can be carried out by the communication antenna 7. When there is another communication device 1 within a communicable range in the state where the wireless communication function is ON, wireless communication is established. On the other hand, the state where the wireless communication function is OFF means a state where power supply to the communication antenna 7 is suspended so that wireless communication cannot be carried out by the communication antenna 7.

In addition, the communication controller 8 disconnects wireless communication when data transmission/reception is not carried out for a given period of time in the ON state of the wireless communication function. That is, unintended data transmission/reception is prevented from occurring because the data transmission/reception can be carried out for a long time, so that leakage of information is suppressed. In this case, a threshold time for use is also stored in the register 8a. The acceleration-based wireless communication control function to be executed by the communication controller 8 may be changed over by an application or may be changed over by a switch provided in the housing 2.

The acceleration detector 10 performs suitable signal processing on measured data indicating the acceleration of the communication device 1 measured by the acceleration sensor 9. Thus, the acceleration detector 10 detects acceleration information showing the inclination or movement of the communication device 1, vibration or impact on the communication device 1, etc. The detected acceleration information is sent out to the controller 17.

The input module 11 receives an operation from a user, and generates a signal indicating the operation. The generated signal is supplied to the controller 17. The embodiment has been described in the case where the input module 11 has buttons provided to be exposed in the housing cover 2A. However, when the touchscreen 3A is provided, the touchscreen 3A is included in the input module 11.

The battery controller 13 uses the battery 12 to generate a system power source to be supplied to each component of the communication device 1. The battery 12 is a power supply source for operating each component of the communication device 1.

The memory controller 15 is a controller for controlling the memory 14. The memory 14 is a so-called working memory for expanding an operating system and various application programs in accordance with the control of the memory controller 15.

The timing module 16 is a chip having a timing function. For example, the timing module 16 is a Real Time Clock (RTC) or the like.

The controller 17 is a processor provided for controlling the operation of the communication device 1. The controller 17 executes an operating system and various application programs so as to control the operation of each module of the communication device 1. That is, the controller 17 starts up a system control program and various processing programs recorded in advance, in accordance with signals inputted from the input module 11, so as to control the operation of each module of the communication device 1.

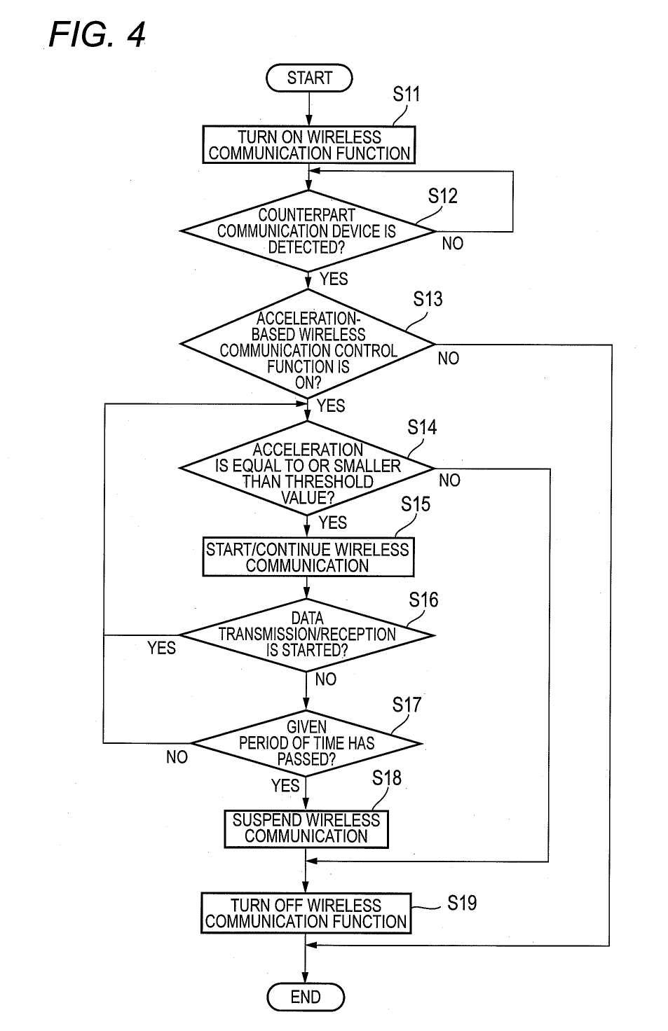

FIG. 4 is a flow chart showing a communication control procedure of the communication device 1. The procedure for the communication controller 8 of the communication device 1 to control the wireless communication function will be described with reference to FIG. 4.

First, the communication controller 8 turns on the wireless communication function of the communication antenna 7 (Step S11). That is, electric power from the battery 12 is supplied to the communication antenna 7 by the communication controller 8 so that the wireless communication can be carried out by the communication antenna 7.

Next, it is determined whether a counterpart communication device 1 as a communication partner has been detected or not (Step S12). That is, it is determined whether there is the counterpart communication device 1 within the communication range of the communication antenna 7 or not.

When it is determined that no counterpart communication device 1 has been detected (No at Step S12), the procedure returns to Step S12. On the other hand, when it is determined that the counterpart communication device 1 has been detected (Yes at Step S12), the communication controller 8 next determines whether the acceleration-based wireless communication control function has been set in an ON state or not (Step S13).

When it is determined that the acceleration-based wireless communication control function has not been set in the ON state (No at Step S13), the communication control procedure is terminated. On the other hand, when it is determined that the acceleration-based wireless communication control function has been set in the ON state (Yes at Step S13), the communication controller 8 determines whether a magnitude of acceleration indicated by the detected acceleration information is within a threshold value or not (Step S14). That is, the communication controller 8 determines whether the acceleration information detected based on a measured value received from the acceleration sensor 9 exceeds the threshold value stored in the register 8a or not.

When it is determined that the detected acceleration is greater than the threshold value (No at Step S14), the communication controller 8 turns off the wireless communication function (Step S19). That is, there is a possibility that movement of the communication device 1 may make the communication device 1 close to the counterpart communication device 1 accidentally to start wireless communication therewith. In order to prevent data leakage due to such wireless communication not intended by the user, power supply to the communication antenna 7 is suspended.

On the other hand, when it is determined that the magnitude of the acceleration indicated by the detected acceleration information is equal to or smaller than the threshold value (Yes at Step S14), wireless communication is started (Step S15).

Next, the communication controller 8 determines whether data transmission/reception has been started or not (Step S16). When it is determined that data transmission/reception has been started (Yes at Step S16), the acceleration of the communication device 1 is detected again (Step S14). When it is determined that the magnitude of the acceleration indicated by the detected acceleration information is equal to or smaller than the threshold value (Yes at Step S14), the wireless communication is continued (Step S15).

On the other hand, when it is determined in Step S16 that data transmission/reception has not been started (No at Step S16), the communication controller 8 next determines whether a given period of time has passed or not (Step S17). That is, the communication controller 8 performs timing in the timing module 16 and determines whether a period of time not shorter than a threshold time stored in the register 8a has passed or not.

When it is determined in Step S17 that the given period of time has not passed (No at Step S17), the acceleration of the communication device 1 is detected again (Step S14). When it is determined in Step S14 that the magnitude of the acceleration indicated by the detected acceleration information is equal to or smaller than the threshold value (Yes at Step S14), the wireless communication is continued (Step S15).

On the other hand, when it is determined in Step S17 that the given period of time has passed (Yes at Step S17), the wireless communication is suspended (Step S18). That is, the wireless communication is suspended when data transmission/reception is not started though data can be transmitted/received between communication devices 1 staying still and close to each other.

Next, the communication controller 8 turns off the wireless communication function of the communication antenna 7 (Step S19). That is, the power supply to the communication antenna 7 is suspended to save the power consumption of the communication device 1. Thus, the wireless communication function control procedure carried by the communication controller 8 is terminated.

As described above, there is assumed a situation in which the communication device 1 may approach another communication device 1 accidentally when the communication device 1 is moving. When the wireless communication function is set as ON in such circumstances, there is a possibility that wireless communication not intended by the user may be established. According to the embodiment, wireless communication can be controlled in concert with the movement of the communication device 1. That is, wireless communication is disconnected during the movement of the communication device 1 so that data leakage caused by wireless communication not intended by a user can be suppressed. In addition, the wireless communication function of the communication antenna 7 is turned off in concert with the movement of the communication device 1 so that the power supply to the communication antenna 7 can be suspended accordingly each time. Thus, power consumption of the communication device 1 can be saved.

In the embodiment, a portable device has been described as the communication device 1 by way of example. The embodiment is not limited to such a portable device, but may be applied to a device which is mounted in use. A modification of the embodiment will be described in the case where the communication device 1 is applied to a personal computer with a wireless communication function.

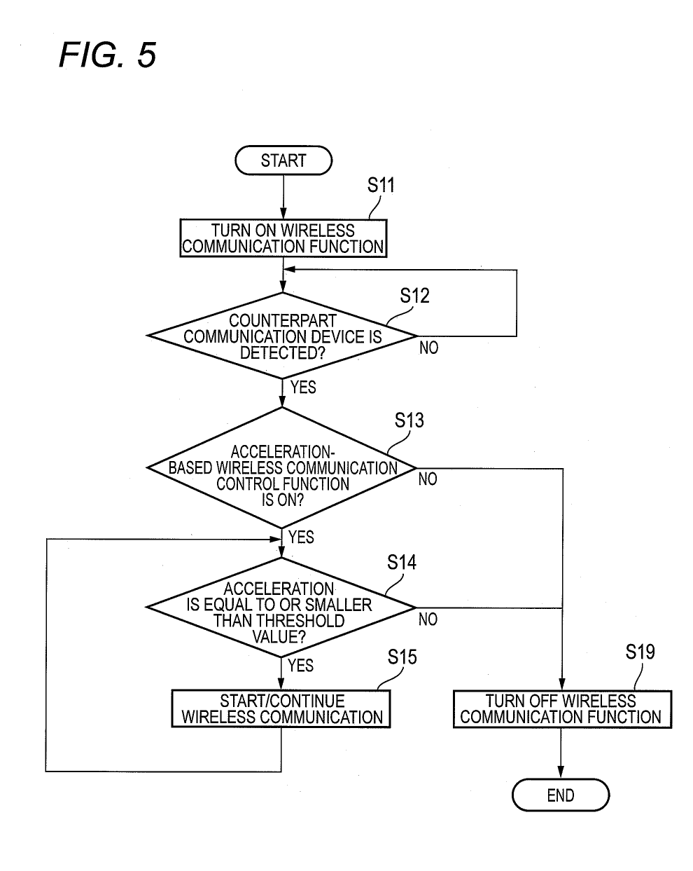

FIG. 5 is a flow chart showing a communication control procedure of the communication device 1 according to the modification of the embodiment. In the modification, Steps S16 to S18 in the flow chart of FIG. 4 are omitted. In the modification of the embodiment, a device such as a personal computer, which is placed stationarily on a desk when wireless communication is performed, is regarded as the communication device 1. In such a device, it is assumed that the state where data transmission/reception is not performed is often continued. Accordingly, even when a given period of time has passed in the state where data transmission/reception is not carried out, the wireless communication function is not set as OFF, but wireless communication is continued. Thus, even when the state where data transmission/reception is not carried out is continued, the labor to set the wireless communication function as ON again is not required.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A wireless communication device comprising:
a wireless communication module configured to execute wireless communication with a counterpart communication device;
an acceleration detector configured to detect acceleration of the communication device; and
a communication controller configured to determine whether the acceleration exceeds a threshold value, and to disconnect the wireless communication when the communication controller determines that the acceleration exceeds the threshold value.

2. The device of claim 1, wherein
based on when the communication controller determines that the acceleration does not exceed the threshold value, the communication controller is configured to determine whether a state where the data communication is not carried out is continued for a given period of time, and
the communication controller is configured to disconnect the wireless communication based on when the communication controller determines that the state is continued for the given period of time.

3. The device of claim 1 further comprising:
a battery configured to serve as a power supply source of the communication device; and
a battery controller configured to control power supply from the battery to each module of the communication device; wherein:
the battery controller is configured to suspend the power supply to the wireless communication module when the wireless communication is disconnected.

4. The device of claim 2 further comprising:
a battery configured to serve as a power supply source of the communication device; and
a battery controller configured to control power supply from the battery to each module of the communication device; wherein:
the battery controller is configured to suspend the power supply to the wireless communication module when the wireless communication is disconnected.

5. A method of controlling a wireless communication device comprising:
establishing wireless communication with a counterpart communication device;
detecting acceleration of the communication device;
determining whether the detected acceleration exceeds a threshold value; and
disconnecting the wireless communication when it is determined that the acceleration exceeds the threshold value.

6. The method of claim 5 further comprising:
determining whether a state where the data communication is not carried out is continued for a given period of time when it is determined that the detected acceleration does not exceed the threshold value; and
disconnecting the wireless communication when it is determined that the state is continued for the given period of time.

7. The method of claim 5 further comprising:
supplying electric power to an antenna configured to execute the wireless communication;
determining whether the wireless communication is disconnected; and
suspending power supply to the antenna when it is determined that the wireless communication is disconnected.

8. The method of claim 6 further comprising:
supplying electric power to an antenna configured to execute the wireless communication;
determining whether the wireless communication is disconnected; and
suspending power supply to the antenna when it is determined that the wireless communication is disconnected.
